(19) United States
(12) Patent Application Publication
(10) Pub. No.: US 2011/0265518 A1
(43) Pub. Date: Nov. 3, 2011

(54) MANUFACTURING METHOD OF HERMETIC CONTAINER AND IMAGE DISPLAY APPARATUS

(75) Inventors: Mamo Matsumoto, Kawasaki-shi (JP); Nobuhiro Ito, Yamato-shi (JP)

(73) Assignee: CANON KABUSHIKI KAISHA, Tokyo (JP)

(21) Appl. No.: 13/079,104

(22) Filed: Apr. 4, 2011

(30) Foreign Application Priority Data
Apr. 30, 2010 (JP) 2010-105525

(51) Int. Cl. C03C 27/00; C03B 29/00

(52) U.S. Cl. 65/43

(57) ABSTRACT

A manufacturing method of a hermetic container includes the steps of sandwiching a frame-like sealing material between a first glass substrate and a second glass substrate, irradiating first local heating light to a first region of the sealing material, and sealing the first glass substrate and the second glass substrate to each. The sealing is performed by irradiating, on a boundary between the first region of the sealing material and a second region of the sealing material which is adjacent to the first region and on which the first local heating light is not irradiated, second local heating light to heat and melt a portion of the second region adjacent to the boundary, during a period that viscosity of the sealing material at a portion of the first region adjacent to the boundary is equal to or lower than 10¹⁸ Pa·sec.

### BACKGROUND OF THE INVENTION

1. Field of the Invention

The present invention relates to a manufacturing method of a hermetic container and a manufacturing method of an image display apparatus, and more particularly, to a manufacturing method of an image display apparatus the inside of which is vacuumized and which has an electron-emitting device and a phosphor film.

2. Description of the Related Art

Image display apparatuses of a flat panel type such as an organic LED (light-emitting diode) display (OLED), a field emission display (FED), a plasma display panel (PDP), and the like are well known. Each of these image display apparatuses is manufactured by hermetically sealing glass substrates which face each other, and has a container in which an internal space is partitioned to an external space. To manufacture such a hermetic container, a spacing distance defining member, a local adhesive, and the like are arranged between the facing glass substrates as necessary, a sealing material is arranged like frame to peripheral portions of the glass substrates, and then a heat sealing process is performed. An example of a hermetic container manufactured in this way is illustrated in FIG. 7A. As a heating method of the sealing material, a method whereby the whole glass substrates are baked by a furnace and a method whereby the periphery of the sealing material is selectively heated by local heating are known. The local heating is more advantageous than the whole heating from viewpoints of a time which is required to heat and cool, an energy which is required to heat, productivity, a prevention of thermal deformation of the container, a prevention of thermal deterioration of a function device arranged in the container, and the like. In particular, a laser beam has been known as a means for performing the local heating.

United States Patent Application Publication No. 2006/0082298 discloses a method of manufacturing a container of an OLED. In this method, a frame member and a sealing material (frit) are first arranged at a circumferential portion of first and second glass substrates arranged to face each other, and a laser beam is then irradiated along a sealing material extending direction so as to substantially maintain a certain temperature in the sealing material, thereby achieving hermetical sealing.

Japanese Patent Application Laid-Open No. 2008-059781 discloses a method of manufacturing a container of an FED or a PDP. In this method, a sealing material is arranged between respective four sides of first and second glass substrates arranged to face each other, a laser beam is irradiated to the respective sealing materials on the four sides, and the respective sealing materials on the four sides are melted together, thereby obtaining a hermetic container.

As just described, conventionally, in addition to a method of simply irradiating a laser beam respectively to four sides, various sealing methods in which a laser irradiation condition is changed, an irradiation route is changed, irradiation order is changed, and/or the like have been known. However, as illustrated in FIG. 7B, when local heating light 58 is scanned along a sealing material to obtain a hermetic container having continuous and closed sealing as illustrated in FIG. 7A, a problem of occurrence of a crack arises, whereby there is a case where reliability concerning airtightness and joining strength decreases. It is thought that the above problem arises because, when the local heating light 58 is used, a region (sealed portion) 56 to which the local heating light 58 has been irradiated and a region (unsealed portion) 57 to which the local heating light 58 is not irradiated mixedly exist as illustrated in FIG. 7B. In other words, it is thought that histories of sealing of the respective sides are related to the above problem.

The present invention aims to provide a manufacturing method of a high-reliable hermetic container which achieves both joining strength and airtightness.

### SUMMARY OF THE INVENTION

The present invention relates to a manufacturing method of a hermetic container, which includes sealing a first glass substrate and a second glass substrate for forming at least a part of the hermetic container together with the first glass substrate, to each other.

The present invention includes: sandwiching a frame-like sealing material between a first glass substrate and a second glass substrate; irradiating first local heating light to a first region of the sealing material; and sealing the first glass substrate and the second glass substrate to each other by irradiating, on a boundary between the first region of the sealing material and a second region of the sealing material which is adjacent to the first region and on which the first local heating light is not irradiated, second local heating light to heat and melt a portion of the second region adjacent to the boundary, during a period that viscosity of the sealing material at a portion of the first region adjacent to the boundary is equal to or lower than 10¹⁸ Pa·sec.

The present invention further includes: a step of forming a sealing material, of which viscosity has a negative temperature coefficient and softening point is lower than softening points of the first and second glass substrates, like frame on the first glass substrate; a step of arranging the second glass substrate to face the first glass substrate on which the sealing material has been formed, so as to contact the sealing material; and a step of sealing the first glass substrate and the second glass substrate to each other by irradiating local heating light to the sealing material along a direction extending like frame on the sealing material, wherein, on a boundary between a first region of the sealing material to which the local heating light is irradiated and a second region of the sealing material which is adjacent to the first region and on which the local heating light is not irradiated, the local heating light is irradiated to heat and melt a portion of the second region adjacent to the boundary, during a period that viscosity of the sealing material at a portion of the first region adjacent to the boundary is equal to or lower than 10¹⁸ Pa·sec.

According to the present invention, the local heating light is irradiated to the second region (unsealed portion) adjacent to the first region (sealed portion) on which the local heating light is irradiated, during the period that the viscosity of the sealing material at the portion (sealing material boundary region) of the sealed portion adjacent to the boundary between the sealed portion and the unsealed portion is equal to or lower than 10¹⁸ Pa·sec. Thus, although the viscosity of the sealing material on the unsealed portion decreases, the local heating light is irradiated also to the boundary between the sealed portion and the unsealed portion, whereby the viscosity of the sealing material in the sealing material boundary region again decreases before a temperature returns to a room temperature. As a result, a local contraction difference of the sealing material causing occurrence of a crack decreases, whereby the high-reliable hermetic container which achieves both the joining strength and the airtightness can be obtained.

Further features of the present invention will become apparent from the following description of exemplary embodiments with reference to the attached drawings.

### BRIEF DESCRIPTION OF THE DRAWINGS

FIG. 1 is a partially broken perspective view illustrating an FED to which a manufacturing method of a hermetic container according to the present invention is applicable.

FIGS. 2A, 2B, 2C, 2D, 2E, 2F, 2G, 2H, 2I, 2J, 2K, 2L, 2M, 2N and 2O are respectively perspective views illustrating an example of a process flow according to the present invention.

FIG. 3 is a plan view illustrating respective states of sealed and unsealed portions.

FIG. 4 is an exemplificative characteristic view illustrating relationship between viscosity of a sealing material and frequency of crack occurrence in a case where second local heating light is irradiated.

FIG. 5 is an exemplificative characteristic view illustrating relationship between the viscosity of the sealing material at the sealed portion adjacent to a boundary between the sealed and unsealed portions and an elapsed time.

FIGS. 6A, 6B, 6C and 6D are plan views indicating irradiation methods of first local heating light and second local heating light.

FIGS. 7A and 7B are plan views and cross sectional views for describing states that a hermetic container is manufactured.

### DESCRIPTION OF THE EMBODIMENTS

Preferred embodiments of the present invention will now be described in detail in accordance with the accompanying drawings.

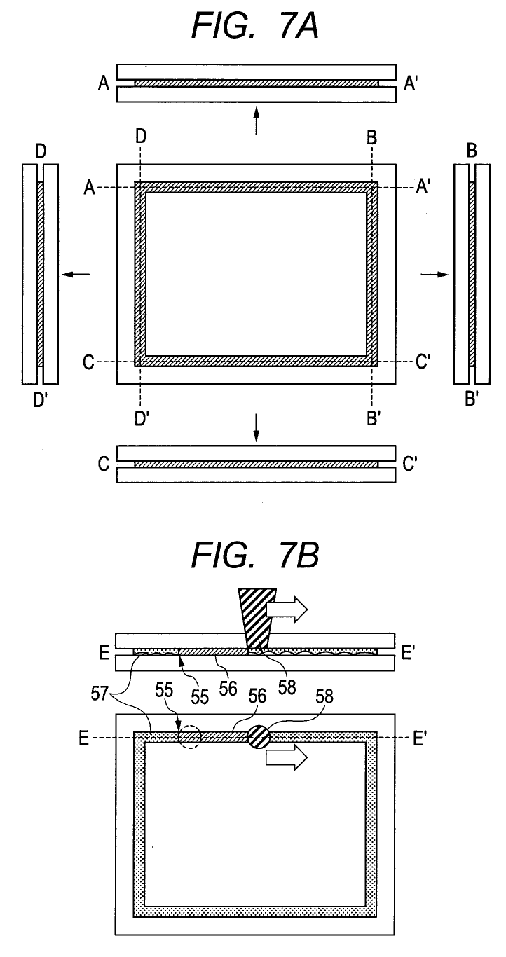

The present inventors and the like analyzed cause of crack occurrence by microscopically observing, with use of a high-speed camera, growth behavior of the crack at the history occurrence point (temporal joint) by the above-described histories of sealing at the respective sides to be sealed. As a result, it was found that a local contraction difference occurred between the sealed portion 56 and the unsealed portion 57 in the cooling process of the sealed portion 56 illustrated in FIG. 7B, the crack due to the local contraction difference occurred in the glass substrate in the vicinity of a boundary 55 between the sealed portion 56 and the unsealed portion 57, and the occurred crack caused deterioration of the reliability concerning the airtightness and the joining strength of the sealed portion due to the history of sealing.

Hereinafter, embodiments of the present invention will be described in detail in accordance with the accompanying drawings. A manufacturing method of a hermetic container according to the present invention can be applied to a manufacturing method of an container to be used for an FED, an OLED, a PDP or the like having a device of which an internal space is required to be hermetically cut off from an external atmosphere. Especially, in an image display apparatus such as the FED or the like of which the inside is set as an evacuated space, a joining strength which can withstand an atmospheric pressure load generated due to a negative pressure of the internal space is required. Here, according to the manufacturing method of the hermetic container according to the present invention, both securement of the joining strength and airtightness can be highly achieved. However, the manufacturing method of the hermetic container according to the present invention is not limited to the above-described manufacturing method of the hermetic container but can be widely applied to a manufacturing method of a hermetic container having sealed portions, which are required to have airtightness, on peripheral portions of the glass substrates facing each other.

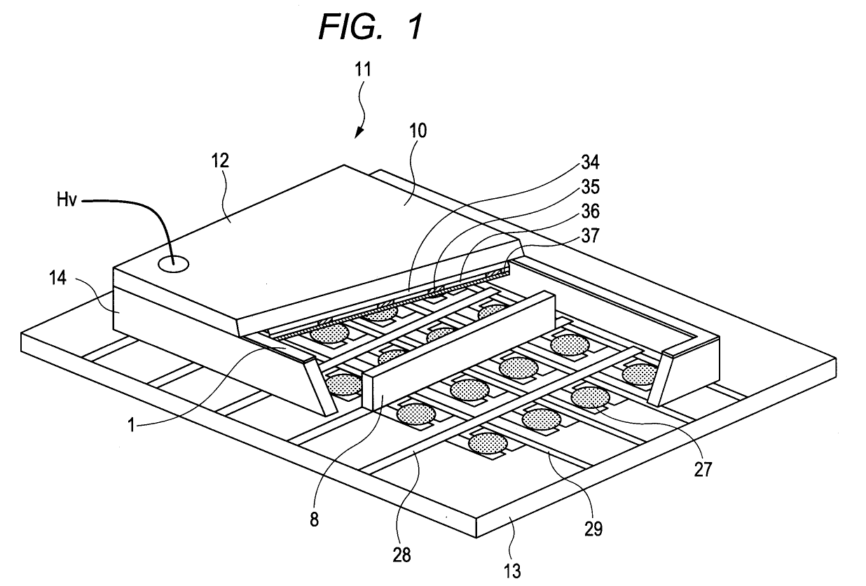

FIG. 1 is a partially broken perspective view illustrating an example of an image display apparatus to be targeted to the present invention. A container (hermetic container) 10 of an image display apparatus 11 has a face plate 12, a rear plate 13 and a frame member 14, which are respectively made of glass. The frame member 14, which is positioned between the face plate 12 and the rear plate 13 having plate shapes respectively, forms a hermetic space between the face plate 12 and the rear plate 13. More specifically, the face plate 12 and the frame member 14, and the rear plate 13 and the frame member 14 are respectively sealed with each other through a sealing material 1 by the planes which face each other, thereby forming the container 10 having a sealed internal space. The internal space of the container 10 is maintained to be a vacuum state, and spacers 8 serving as a spacing distance defining member set between the face plate 12 and the rear plate 13 are provided at a predetermined pitch. The face plate 12 and the frame member 14, or the rear plate 13 and the frame member 14 may be previously sealed to each other or may be integrally formed.

A large number of electron-emitting devices 27 for emitting electrons in response to an image signal are provided on the rear plate 13, and matrix wirings for driving (X-directional wirings 28 and Y-directional wirings 29) for operating each of the electron-emitting devices 27 in response to the image signal are formed. A phosphor film 34 composed of phosphor for emitting light and displaying an image upon receiving the irradiation of electrons emitted from the electron-emitting devices 27 is provided on the face plate 12 positioned to face the rear plate 13. A black stripe 35 is further provided on the face plate 12. The phosphor films 34 and the black stripes are provided with a state that those are mutually arranged. A metal back 36 composed of a thin Al film is formed on the phosphor film 34. The metal back 36, which has a function of serving as an electrode for attracting electrons, receives potential supplied from a high-voltage terminal Hv provided in the container 10. A non-evaporable getter 37 composed of a thin Ti film is formed on the metal back 36.

Since it is sufficient that the face plate 12, the rear plate 13 and the frame member 14 are transparent and have translucency, soda lime glass, high strain point glass, non-alkaline glass or the like can be used. It is desirable that these glass members have excellent wavelength translucency in a used wavelength of local heating light and an absorption wavelength region of a sealing material to be described later.

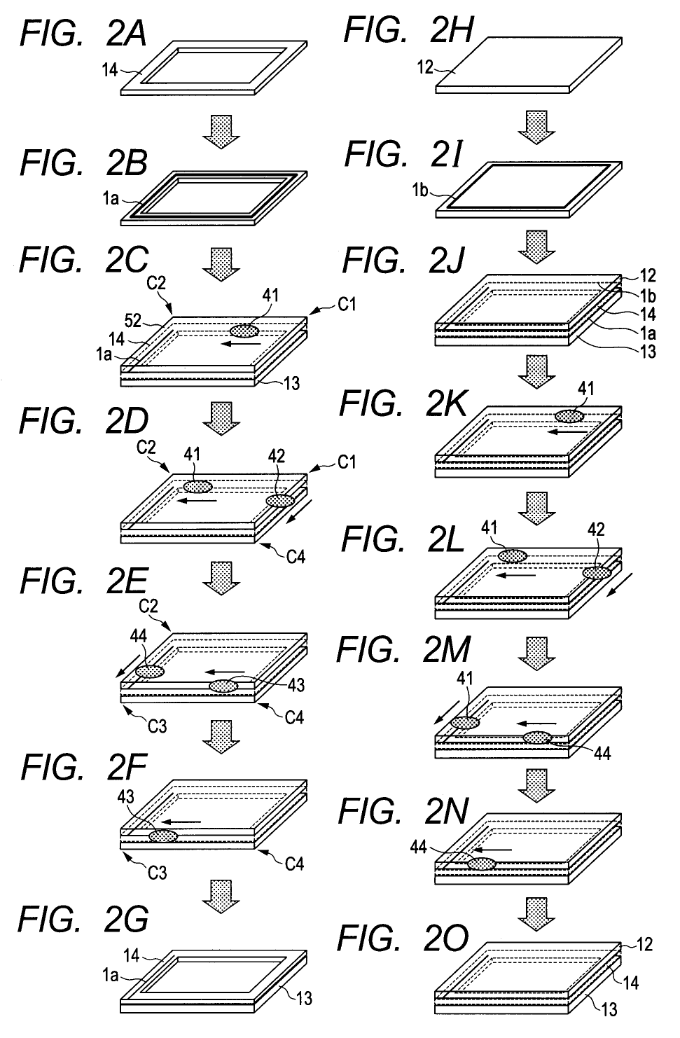

Next, a sealing method of a glass substrate in the manufacturing method of the hermetic container according to the present invention will be described with reference to FIGS. 2A to 2O, FIG. 3, FIG. 4, FIG. 5, and FIGS. 6A and 6B. Incidentally, in the following description, a first glass substrate is used in a meaning of a substrate on which a sealing material is formed, and a second glass substrate is used in a meaning of a substrate which is positioned to face the first glass substrate. For this reason, there are some cases where concrete members meant by the first and second glass substrates are different respectively.

(Step 1)

Initially, as illustrated in FIG. 2A, the frame member 14 (first glass substrate) is prepared. Next, as illustrated in FIG. 2B, a sealing material 1a is formed on the frame member 14, so as to have a frame shape which includes a plurality of straight line portions (sides) and a coupling portion (corner portion) for connecting the straight line portions. Here, viscosity of the sealing material 1a may have a negative temperature coefficient, and the material may be softened at a high temperature. Further, it is desirable that a softening point of the sealing material is lower than that of each of the face plate 12, the rear plate 13 and the frame member 14. As an example of the sealing material 1a, a glass frit, an inorganic adhesive, an organic adhesive or the like is mentioned. It is desirable that the sealing material 1a shows high absorbability in regard to a wavelength of the later-described local heating light. In a case where the hermetic container is used as a container such as an FED or the like in which it is required to maintain a vacuum degree of the internal space, a glass frit or an inorganic adhesive capable of suppressing decomposition of residual hydrocarbon is desirably used as the sealing material.

(Step 2)

Next, as illustrated in FIG. 2C, the rear plate 13 (second glass substrate) on which the electron-emitting devices 27 and the like are formed is arranged to face the frame member 14. At this time, to secure contact between the sealing material 1a and the rear plate 13 and make a pressure strength to the sealing material 1a uniform, it is desirable to supplementarily cover the frame member 14 by a third glass substrate (boundary) 52 to press the sealing material 1a.

(Step 3)

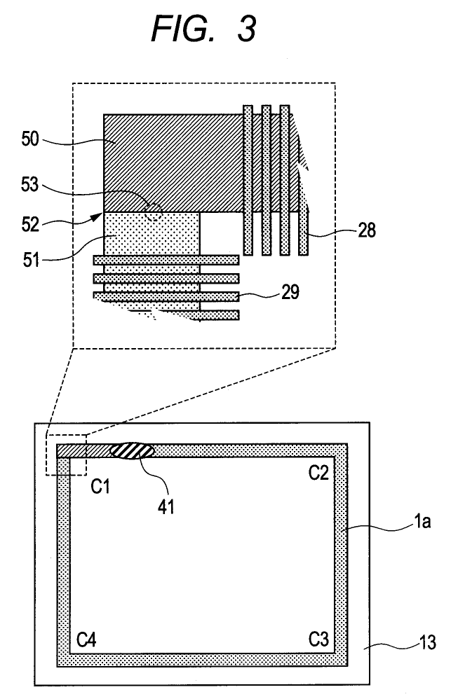

Next, as illustrated in FIGS. 2C and 3, first local heating light 41 is irradiated from an arbitrary position on the sealing material 1a along the frame shape. In the present embodiment, the position from which the irradiation of the first local heating light 41 starts is a first corner portion C1. By the irradiation of the first local heating light 41, the sealing material 1a is sequentially heated and melted in the direction extending along the frame shape of the sealing material 1a. After then, the temperature of the melted sealing material 1a decreases to be equal to or lower than a melting point, and a sealed portion 50 between the rear plate 13 and the frame member 14 is sequentially formed, in a partial region of the sealing material 1a, in the direction extending along the frame shape of the sealing material 1a. Subsequently, after the irradiation of the first local heating light 41, as illustrated in FIGS. 2D, 2E, 2F and 2G, second, third and fourth local heating lights 42, 43 and 44 are irradiated to the respective sides of the sealing material 1a extending along the frame shape to form the sealed portions on the respective sides, thereby sealing the rear plate 13 and the frame member 14 to each other.

As described above, since the viscosity of the sealing material 1a has the negative temperature coefficient, the viscosity once decreases when the material is heated and melted, whereby the material fluidizes. However, after the end of the irradiation, the viscosity recovers and thus returns to the state in a room temperature. In a viscosity recover process of the sealing material 1a, that is, in a cooling process, there is a contraction difference between the sealed portion (first region) 50 to which the local heating light was irradiated and an unsealed portion (second region) 51 to which the local heating light is not irradiated. When the sealed portion 50 returns to the state in the room temperature, the contraction difference between the sealed portion 50 and the unsealed portion 51 increases. Thus, a residual stress at the boundary 52 between the sealed portion 50 and the unsealed portion 51 increases, whereby a crack occurs in the glass substrate in the vicinity of the boundary 52. For this reason, it is desirable that the unsealed portion 51 adjacent to the sealed portion 50 formed by the first local heating light 41 is heated and melted by the second local heating light 42 before the sealed portion 50 adjacent to the unsealed portion 51 returns to the state in the room temperature. More specifically, it is desirable that the second local heating light 42 is irradiated to a part of the unsealed portion 51 adjacent to the boundary 52 during a period that the viscosity of the sealing material at a part (sealed portion boundary region) 53 of the sealed portion 50 adjacent to the boundary of the sealed portion to the unsealed portion 51 has sealing material viscosity being equal to or lower than 10¹⁸ Pa·sec. Consequently, the second local heating light 42 is irradiated also to the sealed portion boundary region 53, whereby the viscosity of the sealed portion again decreases before the sealed portion boundary region 53 returns to the state in the room temperature. As a result, local the contraction difference of the sealing material reduces, whereby occurrence of the crack can be avoided.

FIG. 4 is the graph indicating frequency of crack occurrence empirically obtained in a case where the second local heating light 42 is irradiated in regard to the viscosity of the sealing material of the sealed portion boundary region 53 illustrated in FIG. 3. As illustrated in FIG. 4, a rate of crack occurrence increases in a case where the viscosity of the sealing material of the sealed portion boundary region 53 is equal to or higher than 10¹⁸ Pa·sec. All of such cracks occur in the glass substrate in the vicinity of the boundary 52 between the sealed portion 50 and the unsealed portion 51. On the other hand, it is understood that occurrence of the cracks is greatly suppressed when the second local heating light 42 is irradiated to the unsealed portion 51 in the state that the viscosity of the sealing material of the sealed portion boundary region 53 is equal to or lower than 10¹⁸ Pa·sec. However, although not illustrated in FIG. 4, since contraction of the sealing material progresses in the cooling process at a temperature equal to or lower than a temperature of a strain point, a tensile stress occurs at the boundary, whereby there is a possibility that the rate of crack occurrence increases. For this reason, it is more desirable in terms of long-time reliability of the sealed portion that the second local heating light 42 is irradiated within a temperature range which satisfies the condition that the viscosity η of the sealing material is equal to or lower than 10^{13.5} Pa·sec, and thus the sealing material is melted.

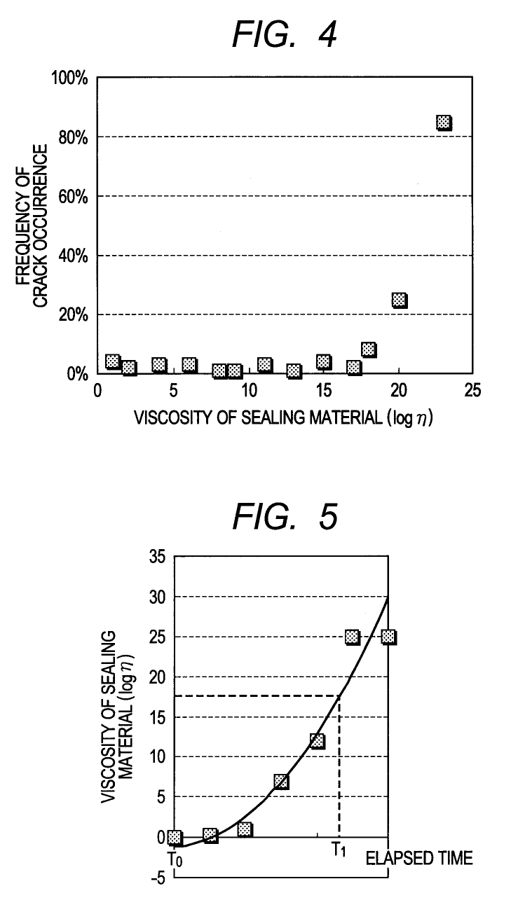

FIG. 5 is the graph indicating relationship between the viscosity of the sealing material of the sealed portion boundary region 53 illustrated in FIG. 3 and an elapsed time from an original point Tₒ being the irradiation start time of the local heating light 41 (that is, the time when the boundary between the sealed portion and the unsealed portion is formed). In FIG. 5, desirable timing at which the second local heating light is irradiated in FIG. 5 is within T₁ corresponding to the state that the viscosity of the sealing material of the sealed portion boundary region 53 is equal to or lower than 10¹⁸ Pa·sec.

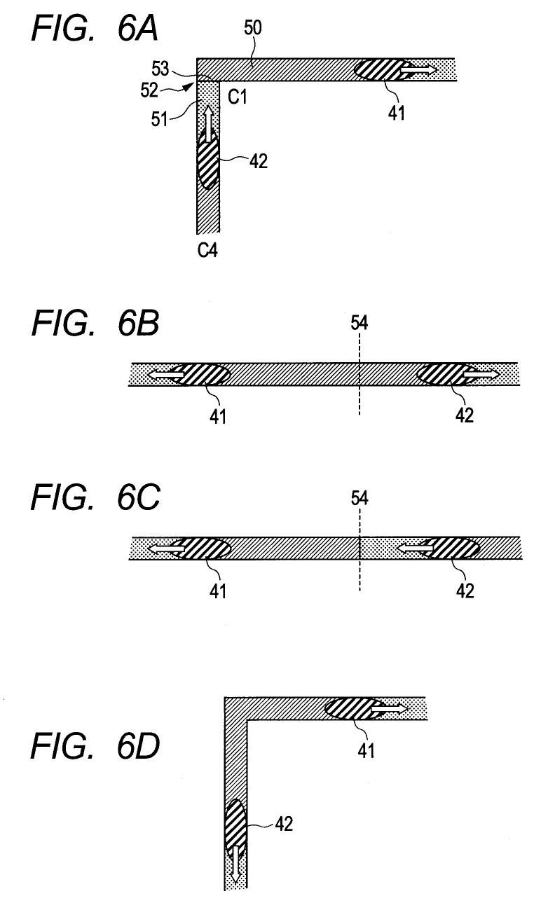

As described above, the timing at which the local heating light is irradiated to the boundary between the sealed portion and the unsealed portion is important in the present invention. On another front, the irradiation start position and the moving and scanning direction of the second local heating light 42 are not limited to those exemplified in FIG. 2D. Namely, as illustrated in FIGS. 6A, 6B and 6C, the irradiation start position and the moving and scanning direction of the second local heating light 42 can be properly changed according to the irradiation start position and the moving and scanning direction of the first local heating light 41. For example, as illustrated in FIG. 6A, when the irradiation of the first local heating light is started from the first corner portion C1, the irradiation of the second local heating light 42 can be started from a fourth corner portion C4, and moved and scanned toward the first corner portion C1. On the contrary, the irradiation of the second local heating light can be started from the first corner portion C1, and moved and scanned toward the fourth corner portion C4. This is similar to a case where the irradiation of the first local heating light 41 is started from an arbitrary straight line portion. That is, as illustrated in FIG. 6B, the irradiation of the second local heating light 42 may be started from a boundary 54 between the sealed portion by the first local heating light 41 and the unsealed portion adjacent to the relevant sealed portion. On the contrary, as illustrated in FIG. 6C, the irradiation of the second local heating light 42 may be ended at the boundary 54. In any case, the second local heating light 42 may be irradiated to melt the sealing material of the unsealed portion adjacent to the sealed portion when the viscosity of the sealing material of the portion of the relevant sealed portion adjacent to the boundary between the relevant sealed portion and the unsealed portion is in a predetermined condition. In other words, the sealing material of the unsealed portion adjacent to the sealed portion may be melted before the above-described viscosity of the sealing material increases up to a value of an equilibrium temperature with surroundings and in a case where the above-described viscosity of the sealing material is equal to or lower than 10¹⁸ Pa·sec (that is, within a lapse time after the irradiation). Therefore, the moving and scanning of the local heating light is not limited.

In the processes of the FIGS. 2C and 2D, the irradiation of the first local heating light 41 is first started from the first corner portion C1 toward a second corner portion C2. Then, after a predetermined interval, the irradiation of the second local heating light 42 is started from the first corner portion C1 toward the fourth corner portion C4. On another front, the irradiation of the second local heating light 42 may be started from the first corner portion C1 toward the fourth corner portion C4 before the irradiation of the first local heating light 41. In this case, as illustrated in FIG. 5, it is desirable that the second local heating light 42 is irradiated with timing that the first local heating light 41 is irradiated to the first corner portion C1 within a time T₁ after the second local heating light 42 is irradiated in first. Further, as illustrated in FIG. 6D, the irradiation of the second local heating light 42 may be started from the first corner portion C1 simultaneously with the irradiation of the first local heating light 41. However, at the first corner portion C1 from which the irradiation is started, the first local heating light 41 and the second local heating light 42 are irradiated simultaneously and thus the temperature of the sealing material 1a becomes equal to or higher than the softening point, whereby there is a fear that reliability decreases due to overheat of the sealing material 1a. From this, it is more desirable that, during a period that the viscosity η of the sealing material of the sealed portion adjacent to the boundary between the sealed portion and the unsealed portion is equal to or higher than 10^{6.7} Pa·sec corresponding to the softening point, the local heating light is irradiated to the sealing material of the unsealed portion adjacent to the relevant boundary, thereby concluding the sealing at the boundary. That is, the irradiation timing of the second local heating light 42 to the unsealed portion is more desirably within the period that the viscosity η of the sealing material of the sealed portion adjacent to the boundary between the sealed portion and the unsealed portion is within a range of 10^{6.7} Pa·sec≦η≦10^{13.5} Pa·sec, that is, equal to or higher than the strain point and equal to or lower than the softening point. Thus, it is further possible to suppress occurrence of the cracks. As described above, the method of irradiating the second local heating light after the interval from the irradiation of the first local heating light, the method of synchronizing the first local heating light and the second local heating light with each other at the respective irradiation start positions, or the like can be used. Namely, the method of irradiating the local heating light is not specifically limited. To irradiate the local heating light to each side of the sealing material, one of the above irradiation methods may be used. Alternatively, a proper combination of the above irradiation methods may be used. Incidentally, it is needless to say that the above-described irradiations of the first local heating light 41 and the second local heating light 42 at the first corner portion C1 can applied also to the irradiations of the local heating lights 41, 42, 43 and 44 at other corner portions C2, C3 and C4.

Each of the first to fourth local heating lights 41 to 44 may be irradiated to be able to locally heat the vicinity of the sealed region, and a semiconductor laser is preferably used as the local heating light. A semiconductor laser for processing which has a wavelength in an infrared region is suitable in terms of performance of locally heating the sealing material 1a, translucency of the glass substrate and the like. Further, since the first to fourth local heating lights 41 to 44 only have to heat a desired sealing-scheduled region, the local heating light may be positioned on the same side with respect to a sealing target or on the opposite sides with respect to the sealing target.

Incidentally, scanning speed, power, a spot diameter size, a wavelength, number of use and the like of the local heating light (laser) can be arbitrarily selected according to industrial productivity, and a temperature characteristic of the sealing material. In the present embodiment, for example, a glass frit having a width equal to or higher than 0.2 mm and equal to or lower than 2.0 mm, a thickness equal to or higher than 5 μm and equal to or lower than 12 μm can be used as the sealing material, and a high strain point glass substrate can be used as the material to be sealed. In this case, each of the first to fourth local heating lights can be applied within a range of the power of 80 W to 1000 W, the wavelength of 808 nm to 980 nm, the spot diameter of 0.8 mmφ to 3.9 mmφ, the scanning speed of 100 mm/sec to 2500 mm/sec. However, the irradiation condition of the local heating light is not limited to such an above-described condition. To achieve preferable sealing, it is desirable to adjust the condition in conformity with the characteristic of the sealing material so that the viscosity of the sealing material of the sealed portion boundary region 53 illustrated in FIG. 3 is equal to or lower than 10¹⁸ Pa·sec.

(Step 4)

Next, as illustrated in FIGS. 2H, 2I, 2J, 2K, 2L, 2M, 2N and 2O, the face plate (first glass substrate) 12 and the frame member (second glass substrate) 14 are sealed to each other in the procedure same as that in the steps 1 to 3. More specifically, first, as illustrated in FIG. 2H, the face plate 12 on which the phosphor film 34 and the like have been formed is prepared. Next, as illustrated in FIG. 2I, a sealing material 1b having a frame shape is formed on the face plate 12 in the same manner as that in the step 1. Next, as illustrated in FIG. 2J, the face plate 12 and the frame member 14 are contacted through the sealing material 1b. In this case, the third glass substrate 52 is not used. Next, as illustrated in FIGS. 2K to 2N, the first to the fourth local heating lights 41 to 44 are sequentially irradiated along the respective sides of the frame-shape sealing material 1b, in the same manner as that in the step 3. Thus, as illustrated in FIG. 2O, the face plate 12 and the rear plate 13 face to each other through the frame member 14 to form the container 10 having an internal space. In the present embodiment, the sealing material 1b is formed on the face plate 12, but the sealing material 1b can be formed on the frame member 14. Incidentally, it is desirable to set kind and physicality of the sealing material 1b, an irradiation condition of the laser beam, and the like to be the same as those in the steps 1 to 3.

In the present embodiment as described above, the rear plate 13 and the frame member 14 are sealed to each other, and further the face plate 12 and the frame member 14 are sealed to each other, whereby the container 10 in which the frame member 14 is sandwiched between the face plate 12 and the rear plate 13 is manufactured. However, more generally, the present invention is to provide the method of manufacturing the hermetic container in which at least a part thereof consists of the rear plate 13 and the face plate 12. Therefore, the glass substrate on which a protruded portion having the shape of the frame member 14 has previously been formed integrally can be used as one of the rear plate 13 and the face plate 12 and then sealed to the other of the plates. Moreover, the face plate 12 and the frame member 14 can be sealed to each other on ahead, and then the rear plate 13 and the frame member 14 can be sealed to each other.

Further, the above-described embodiment is directed to the image display apparatus. However, the present invention is more generally applicable to the sealing between the first glass substrate and the second glass substrate. In this case, all of the first to fourth local heating lights may be irradiated from the side of the first glass substrate, some of the local heating lights may be irradiated from the side of the first glass substrate and the remains thereof may be irradiated from the side of the second glass substrate, or all of the first to fourth local heating lights may be irradiated from the side of the second glass substrate.

Hereinafter, the present invention will be described in detail by citing concrete examples.

### Example 1

By applying the above-described embodiment, the frame member was hermetically sealed to the rear plate, and the frame member was hermetically sealed further to the face plate, whereby the vacuum hermetic container was manufactured.

(Step 1)

First, the face plate 14 was formed. More specifically, a high strain point glass substrate having the thickness of 1.5 mm (PD200: manufactured by Asahi Glass Co., Ltd.) was cut out to have an external shape of 980 mm×580 mm×1.5 mm. Then, a region of 970 mm×570 mm×1.5 mm at the central portion was cut out by cutting work, and the frame member 14 of which the cross sectional surface was almost rectangle having a width of 5 mm and a height of 1.5 mm was formed. Subsequently, the surface of the frame member 14 was degreased by organic solvent cleaning, pure water rinsing and UV-ozone cleaning.

Next, the sealing material 1a was formed on the frame member 14 so that the sealing material 1a was arranged at the center of the width direction of the frame member 14. In this example, a glass frit was used as the sealing material 1a (and also as the sealing material 1b). The used glass frit was such a paste characterized in that a Bi system lead-free glass frit (BAS115: manufactured by Asahi Glass Co., Ltd.) having a thermal expansion coefficient of α=79×10⁻⁷/° C., a glass transition point of 357° C. and a softening point of 420° C. was treated as a base material and organic substances were dispersed and mixed as a binder. Subsequently, the sealing material 1a having a width of 1 mm and a thickness of 7 μm was formed along the circumferential length on the frame member 14 by using a screen printing method, and then dried at 120° C. Next, to burn out the organic substances, the material was heated and baked at 460° C., thereby forming the sealing material 1a (see FIGS. 2A and 2B).

(Step 2)

Next, an electron-emitting device plate previously having the electron-emitting devices 27, the X-directional wirings 28 and the Y-directional wirings 29 on the glass substrate made of the high strain point glass substrate (PD200) was prepared as the rear plate 13. Next, the frame member 14 having the sealing material 1a thereon and the rear plate 13 were arranged to face each other so that the frame member 14 and the rear plate 13 contact each other through the sealing material 1a. More specifically, the frame member 14 and the rear plate 13 were set to face each other and contacted while aligning them so that the surface of the frame member 14 having the sealing material 1a thereon and the surface of the rear plate 13 having the electron-emitting devices 27 thereon (i.e., the surface being the inner surface of the hermetic container) faced each other. To make a pressure strength to the sealing material 1a uniform, the third glass substrate 52 made of the high strain point glass substrate (PD200) and having the same size as that of the rear plate 13 was put on the frame member 14. Further, to supplement the pressure strength, the third glass substrate 52 was pressed by a not-illustrated pressurizing apparatus. As described above, the rear plate 13 and the frame member 14 were contacted each other through the sealing material 1a (see FIG. 2C).

(Step 3)

Next, the laser beam was irradiated to the temporal assembly structure made of the rear plate 13, the frame member 14, the sealing material 1a and the third glass substrate 52. Four semiconductor laser apparatuses for manufacturing were prepared as the laser beam source. As each of the first to fourth local heating lights 41 to 44, the laser beam having a wavelength of 980 nm and a laser power of 340 W was used, and the laser beam was scanned along each side of the sealing material at speed of 1000 mm/s.

First, the first local heating light 41 was scanned from the first corner portion C1 of the sealing material to the second corner portion C2 (see FIG. 2C). Next, after a lapse of 40 milliseconds from the irradiation of the first local heating light 41 to the first corner portion C1 of the sealing material 1a, the second local heating light 42 was scanned from the first corner portion C1 of the sealing material 1a to the fourth corner portion C4 (see FIG. 2D). Next, after a lapse of 40 milliseconds from the irradiation of the first local heating light 41 to the second corner portion C2 of the sealing material 1a, the fourth local heating light 44 was scanned from the second corner portion C2 of the sealing material 1a to the third corner portion C3 (see FIG. 2E). Finally, after a lapse of 40 milliseconds from the irradiation of the second local heating light 42 to the fourth corner portion C4 of the sealing material 1a, the third local heating light 43 was scanned from the fourth corner portion C4 of the sealing material 1a to the third corner portion C3 (see FIG. 2E). After a lapse of 40 milliseconds from the irradiation of the fourth local heating light 44 to the third corner portion C3 of the sealing material 1a, the third local heating light 43 was irradiated to the third corner portion C3 of the sealing material 1a (see FIG. 2F), whereby the sealing between the rear plate 13 and the frame member 14 was completed (see FIG. 2G).

Here, the state after the irradiation of the first local heating light 41 (that is, after the formation of the boundary 52 between the sealed portion 50 and the unsealed portion 51) and immediately before the irradiation of the second local heating light 42 was confirmed with respect to the first corner portion C1 of the sealing material 1a. More specifically, a temperature immediately before the irradiation of the second local heating light 42 to the sealed portion boundary region 53 (see FIG. 3) was measured by a not-illustrated radiation thermometer. The temperature of the sealed portion boundary region 53 measured by the radiation thermometer was 330° C. to 360° C., corresponding to 10¹¹ Pa·sec to 10¹² Pa·sec in terms of the viscosity of the sealing material 1a. Further, the temperature of the sealed portion boundary region after the irradiation of the local heating light to one side and immediately before the irradiation of the local heating light to the other side was measured by the radiation thermometer with respect to each of other corner portions C2 to C4. The temperature of the sealed portion boundary region of each of the corner portions C2 to C4 measured by the radiation thermometer was 330° C. to 360° C. as well as the temperature of the first corner portion C1, likewise corresponding to 10¹¹ Pa·sec to 10¹² Pa·sec in terms of the viscosity of the sealing material. Further, a peak temperature of the sealing material 1a at the time when the second local heating light 42 was irradiated to the vicinity of the boundary 52 between the sealed portion 50 and the unsealed portion 51 measured by the radiation thermometer was 780° C. to 800° C., and it was confirmed that the sealing material 1a was melted by the second local heating light 42.

(Step 4)

Next, the face plate 12 having a phosphor film or the like thereon was prepared, and the face plate 12 and the frame member 14 were sealed to each other in the same procedure as that in the above steps 1 to 3. In this step, the third glass substrate 52 for pressing was not used, and the laser beam was directly irradiated to the face plate 12. The sealing material 1b was formed on the face plate 12, and irradiation conditions (an arrangement condition, a specification of a laser head, etc.) of the laser beam were set to be the same as those in the step 3 (see FIGS. 2H to 2O).

As just described, the hermetic container was formed, and the formed hermetic container was applied as the container of the FED in a normal manner, thereby completing the image display apparatus. When the completed FED was operated, it was confirmed that stable electron emission and image display for a long time could be performed and such stable airtightness and joining strength as being applicable to the FED were assured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-105525, filed Apr. 30, 2010, which is hereby incorporated by reference herein in its entirety.

1. A manufacturing method of a hermetic container, comprising the steps of:
sandwiching a frame-like sealing material between a first glass substrate and a second glass substrate;
irradiating first local heating light to a first region of the sealing material; and
sealing the first glass substrate and the second glass substrate to each other by irradiating, on a boundary between the first region of the sealing material and a second region of the sealing material which is adjacent to the first region and on which the first local heating light is not irradiated, second local heating light to heat and melt a portion of the second region adjacent to the boundary, during a period that viscosity of the sealing material at a portion of the first region adjacent to the boundary is equal to or lower than 10¹⁸ Pa·sec.

2. A manufacturing method of a hermetic container, which includes sealing a first glass substrate and a second glass substrate of forming at least a part of the hermetic container together with the first glass substrate to each other, comprising:
a step of forming a sealing material-like frame, of which viscosity has a negative temperature coefficient and softening point is lower than softening points of the first and second glass substrates, on the first glass substrate;
a step of arranging the second glass substrate to face the first glass substrate on which the sealing material has been formed, so as to contact the sealing material; and
a step of sealing the first glass substrate and the second glass substrate to each other by irradiating local heating light to the sealing material along a direction of the sealing material-like frame,
wherein the sealing material includes a first region, a second region, and a boundary between the first region and the second region,
the irradiation of the local heating light includes irradiation of first local heating light and irradiation of second local heating light, and
on the boundary between the first region of the sealing material to which the first local heating light is irradiated and the second region of the sealing material which is adjacent to the first region and on which the first local heating light is not irradiated, the second local heating light is irradiated to heat and melt a portion of the second region adjacent to the boundary, during a period that the viscosity of the sealing material at a portion of the first region adjacent to the boundary is equal to or lower than 10¹⁸ Pa·sec.

3. The manufacturing method according to claim 1, wherein the irradiation of the local heating light is performed to heat and melt the portion of the second region adjacent to the boundary during a period that the viscosity of the sealing material at the portion of the first region adjacent to the boundary is within a range of 10^{6.7} Pa·sec to 10^{13.5} Pa·sec.

4. The manufacturing method according to claim 1, wherein one of the first and second glass substrates is a plate-like glass substrate and the other of the first and second glass substrates is a glass frame member or a member obtained by sealing or integrally forming a glass frame member to a plate-like glass substrate.

5. A manufacturing method of an electron beam image display apparatus in which a container is formed by using the manufacturing method of the hermetic container described in claim 1.
